(19) United States
(12) Patent Application Publication
(10) Pub. No.: US 2023/0165217 A1
(43) Pub. Date: Jun. 1, 2023

(54) CORRUGATED CARDBOARD-BASED CAT SCRATCHER

(71) Applicant: WORLDWISE, INC., Novato, CA (US)

(72) Inventors: Shiyu Raymond Guo, San Rafael, CA (US); Jacob Dominguez, Mercedes, TX (US); Aimee Diskin, Napa, CA (US); Hannah Rosenberg, San Francisco, CA (US); Lisa Davis, Farifax, CA (US); Julie Widenhofer, San Anselmo, CA (US); Michael Risso, Napa, CA (US)

(21) Appl. No.: 17/539,141

(22) Filed: Nov. 30, 2021

(51) Int. Cl. A01K 15/02

(52) U.S. Cl. CPC A01K 15/024

(57) ABSTRACT

A cat scratcher in the form of a rigid shell having a planar base and opposing side walls. The opposing side walls extending diagonally and outwardly from the planar base. A first block of open-fluted cardboard is affixed to the planar base and second and third open-fluted cardboard blocks are affixed to the opposing side walls respectively creating an open space within the rigid shell having three open-fluted cardboard surfaces upon which a cat can scratch.

### TECHNICAL FIELD

The present invention is directed to a cat scratcher. The cat scratcher is in the form of an open shell having outwardly extending sloping sidewalls supporting open-fluted corrugated cardboard blocks which create three scratching surfaces and an open region facilitating lounging. The cat scratchers are stackable in order to minimize shipping and warehousing costs. The scratcher is supportive of a pet cat which not only provides support for the cat but also an ideal scratching surface. The corrugate blocks include catnip or silvervine as attractants to encourage the cat to use it as opposed to satisfying its natural scratching instinct on furniture, drapes and the like. Rather than merely applying catnip or silvervine to the surface of the cardboard blocks, it has been determined that significant benefit can be derived by incorporating catnip or silvervine into an aqueous-based adhesive that holds the corrugated scratch components together.

### BACKGROUND OF THE INVENTION

It is quite important for the health and well-being of a pet to not only feed it properly but also provide it with stimulating activities. Pets which become bored oftentimes become destructive not only of their surroundings but also themselves. Animals which are not appropriately stimulated can actually suffer adverse health effects and as a consequence. As such, proper pet stimulation should be a significant consideration for virtually all pet owners.

In addition to pet stimulation, generally, pet cats require surfaces upon which they can lounge and scratch. If an appropriate scratching surface is not provided, cats will use any available surface, including upholstered furniture, drapes and rugs to satisfy their need to scratch potentially causing significant damage.

There have been a variety of cat scratching devices available in the marketplace for quite some time. The most successful of such devices have surfaces which will eventually be worn requiring replacement. Such surfaces include, for example, carpet, sisal, corrugated cardboard, rope and natural fibers.

To stimulate a pet cat and to encourage it to selectively use a dedicated lounging and scratching device rather than furniture, rugs, drapes and the like, it is common to apply catnip or silvervine in the form of ground catnip or silvervine leaves to the scratcher surface. The effect of catnip and silvervine on virtually all feline species is well known. The dry leaves of the catnip and silvervine plants express a mint-like scent. They are euphoric stimulants, although they are not toxic. This “catnip response” is due to the plant's active ingredient, nepetalactone. Similar responses are observed as a result of silvervine's active ingredient actinidine.

Although traditional cat scratchers are applied to a rigid support and are thus self-supporting, such devices occupy significant space within one's household. In situations where space is at a premium, one cannot always employ self-supporting scratchers and alternatives must be found. Self-supporting scratchers are large and bulky and are thus expensive to ship as manufacturers are generally located offshore. This also results in high warehouse and display costs.

It is thus an object of the present invention to provide a cat scratcher with enhanced stimulating properties invoking the appropriate “catnip response.”

It is yet a further object of the present invention to provide a cat scratcher that includes corrugate blocks with the appropriate catnip or silvervine constituents embedded therein and which has exposed open flutes on all of its planar surfaces in order to extend its useful life.

It is still a further object of the present invention to provide a cat scratcher which presents an ideal form factor for minimizing shipping and warehousing costs and yet which is capable of supporting a lounging cat while providing stimulation.

These and further examples will be more readily apparent when considering the following disclosure and appended claims.

### SUMMARY OF THE INVENTION

A cat scratcher comprising a rigid shell having a planar base and opposing side walls, said opposing side walls extending diagonally and outwardly from said planar base, a first block of open-fluted cardboard affixed to said planar base and second and third open-fluted cardboard blocks affixed to said opposing side walls respectively creating an open space within said rigid shell having three open-fluted cardboard surfaces upon which a cat can scratch.

### BRIEF DESCRIPTION OF THE DRAWINGS

FIG. 1 is a perspective view of the cat scratcher the present invention.

FIG. 2 is a perspective view of three cat scratchers of the present invention illustrating the stackability thereof.

FIG. 3A is a perspective view of a corrugated block useful in constituting the cat scratcher the present invention partially constructed.

FIG. 3B is a perspective view of the detail of the cardboard block of FIG. 3A.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

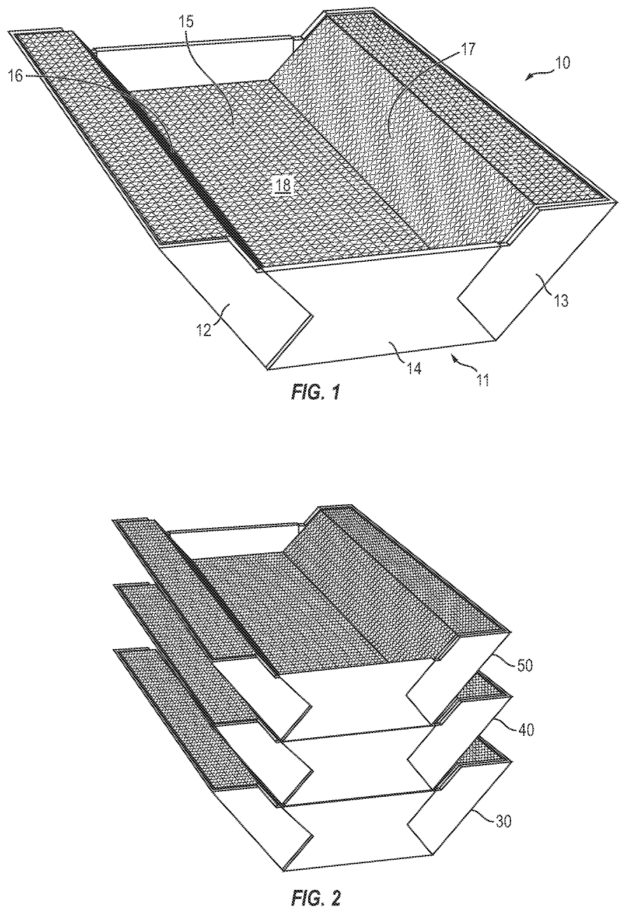

In turning to FIG. 1, cat scratcher 10 is depicted. Cat scratcher 10 comprises rigid shell 11 preferably composed of cardboard bent and configured into the shape as illustrated. Specifically, cat scratcher 10 includes planar base 14 and opposing side walls 12 and 13 which extend diagonally and outwardly from the planar base.

A first block 15 of open-fluted cardboard is affixed to planar base 14 while second and third open-fluted cardboard blocks 16 and 17 are affixed to opposing sidewalls 12 and 13, respectively, creating open space 18 within rigid shell 11. As such, a cat occupying open space 18 would have three distinct scratching surfaces which cats would find not only appealing but also which adds to the longevity of the present invention. It is noted that open space 18 is sized to facilitate a cat lounging within cat scratcher 10 as provided by the planar base and outwardly sloping sidewalls 12 and 13.

As noted in reference to FIG. 2, the geometry of the present cat scratcher facilitates the stacking or nesting of multiple scratchers such as cat scratchers 30, 40 and 50. This is an important consideration as such products are usually manufactured in remote offshore locations only to be shipped and warehoused elsewhere. Shipping costs represent a significant component in the overall pricing of such products and the ability to stack or nest multiple cat scratchers as shown in FIG. 2 minimizes shipping volumes and thus costs. Further, when such products are warehoused by retailers or placed upon shelves for consumer access, stacking minimizes the space required to do so and, as a result, further economies are realized.

It is noted that corrugated cardboard blocks 15, 16 and 17 can be fabricated pursuant to the teachings of U.S. Pat. No. 10,111,406, the disclosure which is incorporated by reference.

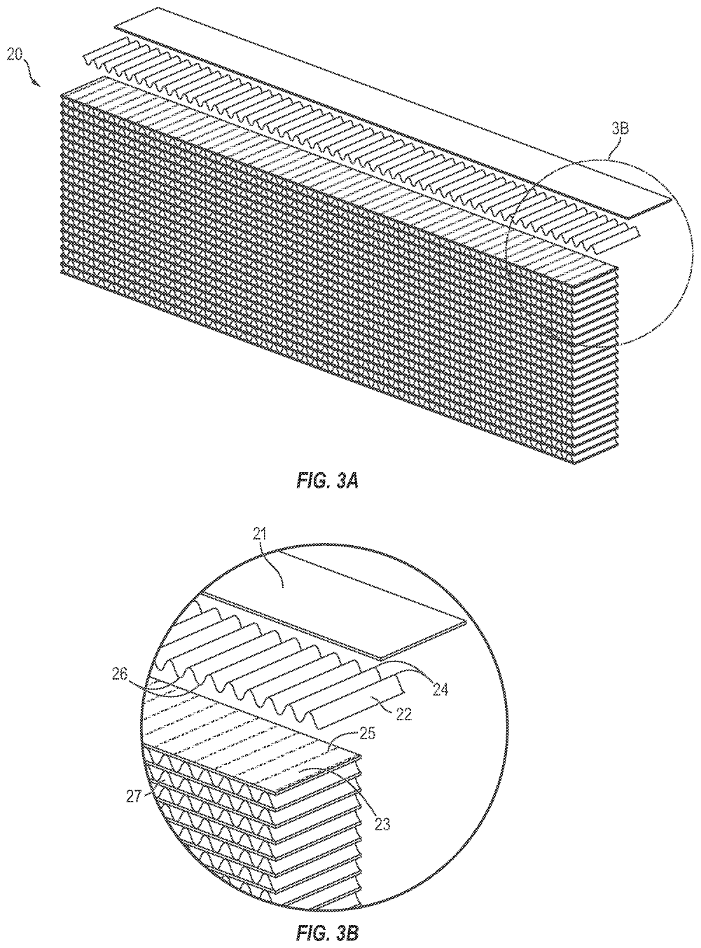

Specifically, FIGS. 3A and 3B depict the present invention as it applies to corrugate body 20 of corrugated cardboard. As is typically the case, corrugated cardboard comprises a plurality of corrugated subparts, specifically, corrugated sheet 22 having peaks 24 and corresponding valleys 26 and planar sheets of kraft paper 21 and 23 separating each corrugated sheet. Beads of adhesive 25 are applied to the kraft paper such that when corrugated sheet 12 is positioned between opposing sheets of kraft paper 21 and 23, cardboard body 20 is fabricated as a singular block. Generally, starch or dextrin-based adhesives are employed as they are non-toxic and thus pose no health risk to an engaging cat.

In the fabrication of prior cardboard-based scratchers, a common adhesive is employed to glue corrugated and planar sheets together and, if desired, ground catnip or silvervine leaves are sprinkled onto the flutes of the finished cardboard block. As the catnip or silvervine is readily available to the pet, it is quickly dissipated and provides the scratcher with no long-term stimulating effects. As a solution to this deficiency inherent in prior scratchers, the present invention employs a catnip or silvervine hydrosol in a suitable aqueous-based adhesive to create beads 25. It has been found that, in doing so, the integrity of the adhesive is not compromised and yet the desired stimulating effects are available for virtually the entire life of the scratcher.

Furthermore, catnip or silvervine hydrosol, alone, or with chopped catnip leaves can be sprayed onto the surface of scratcher body 11 employing, for example, a spray gun to provide catnip or silvervine within the flutes created by corrugated sheets 22. This further enhances the stimulating effects of the scratcher noting that the catnip or silvervine hydrosol penetrates deeply within the flutes and, being a liquid, is absorbed by kraft paper sheets 21 and 23 as well as corrugated sheet 22. Solids, in the nature of chopped catnip or silvervine leaves and/or catnip or silvervine biomass can be included with the catnip or silvervine hydrosol to vary the viscosity of spray 25 to prevent the spray from passing through scratcher body 10 without residing within the flutes as desired employing a proprietary blend of catnip hyrdosol and catnip biomass.

The above disclosure is sufficient to enable one of ordinary skill in the art to practice the invention, and provides the best mode of practicing the invention presently contemplated by the inventor. Notably, as will be appreciated, the techniques of this disclosure provide benefits including efficiency in shipping and increased ability for the cat to relax or lounge in a variety of position, as well as the ability to scratch from different positions, such as standing up or laying on their side(s), along with other advantages. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A cat scratcher comprising a rigid shell having a planar base and opposing side walls, said opposing side walls extending diagonally and outwardly from said planar base, a first block of open-fluted cardboard affixed to said planar base and second and third open-fluted cardboard blocks affixed to said opposing side walls respectively creating an open space within said rigid shell having three open-fluted cardboard surfaces upon which a cat can scratch.

2. The cat scratcher of claim 1 wherein said open space is sized to enable a cat to reside and lounge therein.

3. The cat scratcher of claim 1 wherein said rigid shell and open space are sized with respect to one another to facilitate nesting of multiple cat scratchers within one another for compact shipping and storage.

4. The cat scratcher of claim 1 wherein said rigid shell comprises cardboard.

5. The cat scratcher of claim 1 wherein said first, second and third open-fluted blocks comprise a plurality of corrugated subparts, each corrugated subpart comprising a corrugated sheet having top and bottom surfaces and a planar sheet of kraft paper adhered to said top surface and a planar sheet of kraft paper adhered to said bottom surface, said top and bottom surfaces being adhered to said planar sheets of kraft paper through the use of aqueous-based adhesives comprising catnip, silvervine or mixtures thereof, which helps attract the cat to the product.
